(19) United States
(12) Patent Application Publication
(10) Pub. No.: US 2012/0160498 A1
(43) Pub. Date: Jun. 28, 2012

(54) Concentrated Polymer Systems Having Increased Polymer Loadings and Enhanced Methods of Use

(75) Inventors: Ian D. Robb, Lawton, OK (US); Paul D. Lord, Duncan, OK (US)

(73) Assignee: Halliburton Energy Services, Inc., Houston, TX (US)

(21) Appl. No.: 12/977,998

(22) Filed: Dec. 23, 2010

(51) Int. Cl. E21B 43/26; C09K 8/68

(52) U.S. Cl. 166/308.1; 507/217

(57) ABSTRACT

One method described includes the steps of: providing an HPG concentrate having a polymer load of about 2 to about 25% w/v and being present in a worse-than-theta aqueous solvent, the HPG concentrate comprising HPG polymer and an aqueous based solvent that comprises water and a non-solvent for the HPG that is soluble in the aqueous based solvent; and diluting the HPG concentrate with an aqueous fluid to form a subterranean treatment fluid.

### BACKGROUND

The present invention relates to gelled subterranean treatment fluids, and more particularly, to improved polymer concentrates having increased polymer loadings for use in the efficient preparation of gelled subterranean treatment fluids used in off-shore applications.

Subterranean treatment fluids that are used in an off-shore environment need to be carried to off-shore well sites. They must be carried and pumped from specially designed vessels that necessarily have limited space for on-board storage. After pumping all of the appropriate fluids into the well bore, the vessel must return to the shore to replenish its supplies. Time spent in oscillating between the well and the base is wasteful and significant efficiencies can be obtained if the components of the well bore treatment fluid are of a high concentration, enabling longer treatments per trip of the transportation vessel.

To provide polymers for use in subterranean treatments fluids for off-shore well sites, concentrated polymer systems have been used with some success to facilitate the avoidance of this oscillation between the off-shore well platform and the shore for replenishment. In these systems, the polymer is dissolved in fluid and hydrated up to a limit where it can no longer be pumped as a liquid additive. The polymer load in these concentrated polymer systems is limited by the viscosity of this hydrated polymer; too high of a load results in the inability to pump the concentrate.

At the well site, mixing the polymer with sea water for off-shore use gives the advantage of saving space on the vessels transporting the fluids by avoiding carrying a suitable base fluid so that they can spend more time at the wellhead. Nonetheless, oftentimes, these concentrated systems do not hydrate in a sufficient amount of time to give the necessary gel properties to the resultant gelled treatment fluid. This results in incomplete treatments, and often subsequent and additional trips back to shore for additional polymer, which adds cost and rig time to the job. Increasing the polymer carrying capacity of the vessel by increasing the polymer load in the concentrate is an ideal solution to this recurring problem. But, current systems do not allow for such increased polymer loadings.

Additionally, some current concentrated polymer systems are dispersions of polysaccharides in oil. These systems can present a biocompatibility problem with the ocean in so far as they produce a sheen on the surface of the water if spilled. This makes them unsuitable for many off-shore uses.

### SUMMARY

The present invention relates to gelled subterranean treatment fluids, and more particularly, to improved polymer concentrates having increased polymer loadings for use in the efficient preparation of gelled subterranean treatment fluids used in off-shore applications.

In one embodiment, the present invention provides a method comprising: providing an HPG concentrate having a polymer load of about 2 to about 25% w/v and being present in a worse-than-theta aqueous solvent, the HPG concentrate comprising HPG polymer and an aqueous based solvent that comprises water and a non-solvent for the HPG that is soluble in the aqueous based solvent; and diluting the HPG concentrate with an aqueous fluid to form a subterranean treatment fluid.

In one embodiment, the present invention provides a method comprising: providing an HPG concentrate having a polymer load of about 2 to about 25% w/v and being present in a worse-than-theta aqueous solvent, and diluting the HPG concentrate so as to form a subterranean treatment fluid having better-than-theta conditions; and placing the subterranean treatment fluid in an off-shore well bore.

In one embodiment, the present invention provides a method comprising: providing an HPG concentrate in a storage vessel, the HPG concentrate having a polymer load of about 2 to about 25% w/v and being present at worse-than-theta conditions comprising: HPG polymer, and an aqueous solvent that comprises water and a non-solvent for the HPG polymer, and diluting the HPG concentrate to form a gelled fluid having better than theta conditions; and placing the gelled fluid in a subterranean formation.

In one embodiment, the present invention provides an HPG concentrate having a polymer load of about 2 to about 25% w/v and being present at worse-than-theta conditions comprising HPG polymer and an aqueous based solvent that comprises at least about 5% water and a non-solvent for the HPG and optionally a crosslinking agent.

The features and advantages of the present invention will be readily apparent to those skilled in the art. While numerous changes may be made by those skilled in the art, such changes are within the spirit of the invention.

### BRIEF DESCRIPTION OF THE DRAWINGS

These drawings illustrate certain aspects of some of the embodiments of the present invention, and should not be used to limit or define the invention.

FIG. 1 is described in the Examples section.

FIG. 2 is described in the Examples section.

FIG. 3 is described in the Examples section.

FIG. 4 is described in the Examples section.

FIG. 5 is a schematic of a friction loop used in the experiments described herein.

### DESCRIPTION OF THE PREFERRED EMBODIMENTS

The present invention relates to gelled subterranean treatment fluids, and more particularly, to improved polymer concentrates having increased polymer loadings for use in the efficient preparation of gelled subterranean treatment fluids used in off-shore applications.

Of the many advantages of the present invention is the ability to significantly increase polymer loadings in a hydroxypropyl guar (“HPG”) polymer concentrate. This increase in polymer loading concentration as compared to other concentrated systems, in many cases, is by a factor of 10 or more. This resulting increase in polymer loading is advantageous because it allows for more limited oscillation travel between an off-shore well site and the shore to obtain more polymer concentrate. Thus, the vessel would be able to remain at the well site for longer periods. Consequently, cost savings and efficiencies can be achieved. Additionally, the HPG polymer concentrates of the present invention hydrate with sea water within a relatively quick time to form subterranean treatment fluids that may be used in various subterranean applications including stimulation and completion operations. This rapid hydration of the polymer enables the use of smaller holding/hydration tanks on the vessel and/or shorter residence times for hydration. Moreover, the HPG polymer concentrates of the present invention are aqueous-based, and therefore, do not present the biocompatibility concerns of other systems if a spill should occur inadvertently (i.e., no sheen will form on the surface of the ocean water).

The HPG concentrates comprise HPG polymer and an aqueous based worse-than-theta solvent for the HPG polymer that comprises water and a non-solvent for the HPG polymer that is soluble in the aqueous based solvent. Optionally, the HPG concentrates may comprise crosslinking agents that can crosslink at least some of the HPG polymer within the concentrate. Crosslinking agents can help contribute to the insolubility of the polymer, which may be desirable.

In some embodiments, the present invention provides HPG concentrate compositions that have a polymer load of about 2 to about 25% w/w and are present at worse-than-theta conditions (which are described below). This is a significant advantage over other systems because typical polymer loadings in those are believed to be about 1% w/w or below.

In some instances, in certain embodiments of the present invention, the polymer load may be greater than 25%, but at higher loadings, the concentrate becomes too viscous to pump.

In at least some embodiments, the polymer loading in the HPG concentrates of the present invention is about 200 lb/1000 gal to about 2100 lb/1000 gal. This is a significant polymer loading increase over other systems. 80 lb/1000 gal is typical for fully-hydrated HPG. Thus, at least in some embodiments, with the HPG concentrates of the present invention it is possible to put more than 10 times the amount of polymer in the concentrate as compared to other systems, yet maintain the pumpability of the concentrate.

In terms of overall composition, in some embodiments, the HPG concentrates may contain about 1% to about 25% HPG polymer. In other embodiments, the HPG concentrates may contain about 5% to about 20% HPG polymer. In other embodiments, the HPG concentrates may contain about 10% to about 15% HPG polymer. In some embodiments, the HPG concentrates may contain about 10% to about 12% HPG polymer. In some embodiments, the HPG polymer may be present in an amount up to as much as is compatible with the storage vessel and pumping mechanisms.

Maintaining the pumpability with this level of polymer loading is exceptionally surprising. One skilled in the art may expect this type of concentrate with this much polymer load to be a soft solid-like mass. However, the HPG concentrates of the present invention are free-flowing and pumpable. This is exceptionally advantageous for use in off-shore applications. In most embodiments, surprisingly, the HPG concentrate will have a viscosity that is similar to thin non-crystallized honey. The HPG polymer itself will be contained in a water-rich phase. It is surprisingly “pre-hydrated” because of the aqueous solvent in contact with the polymer chains in the concentrate. On dilution to form a subterranean treatment fluid, this polymer can hydrate rapidly to give a viscous linear gel that can be crosslinked (if desired) and used as usual.

To illustrate this polymer loading difference, the following is provided. The viscosity of 1% solution of fully hydrated HPG in water is approximately 140 cP at 500 s−1 measured on HAAKE “RheoStress RS150” controlled stress rheometer at 23° C. while a 5% solution of HPG in water becomes so viscous that it forms a self-supporting gel that is similar in viscosity to an edible gelled substance known as “JELL-O” and is obviously not pumpable. On the other hand, the viscosity of an HPG concentrate of the present invention having a 16% solution of HPG in a worse-than-theta aqueous solvent (e.g., saturated ammonium sulfate) comprising water and a non-solvent (ammonium sulfate) at ambient temperature is 150 cP at 23° C. at 500 s−1 measured on HAAKE RheoStress RS150 controlled stress rheometer. This 16% solution is pumpable.

The aqueous-based worse-than-theta solvent for the HPG polymer may comprise any suitable aqueous fluid. In some embodiments, the water content of the aqueous based solvent should be an amount of at least about 5% by volume. In other embodiments, between about 5% and about 10% by volume, for example, may be sufficient. In other embodiments, at least 10% may be preferred.

The non-solvent in the worse-than-theta aqueous solvent may be present in an amount sufficient to maintain the HPG in worse-than-theta conditions (which are explained below). Preferred worse-than-theta solvents are those that lead to a phase separation or precipitation of HPG polymer in the solution. The non-solvent can be any water soluble material that, on its own, does not dissolve HPG. Suitable non-solvents include salts, alcohols, glycols, and esters, and any combination thereof. Specific examples include, but are not limited to, dipropylene glycol methyl ether, glycerin, various alcohols, and glycol esters. Examples of suitable salts include but are not limited to, ammonium sulfate, sodium nitrate, potassium carbonate, sodium bromide, potassium chloride, sodium chloride, and any combination thereof. The amount of the non-solvent to be included in the aqueous-solvent composition is an amount sufficient to maintain the concentrate at worse-than-theta conditions.

Optionally, the HPG concentrates can also comprise suitable crosslinking agents. Crosslinking agents may be useful in bringing the solubility of the HPG polymer to worse-than-theta conditions for formation of the HPG concentrate. Suitable crosslinking agents for this purpose include, but are not limited to, non-metal crosslinking agents such as borate crosslinking agents. Sufficient crosslinking agent may be added to restrict the solubility of the HPG in the total solvent and contribute to the worse-than-theta conditions of the total solvent for the HPG. Metal crosslinking agents are not preferred for use in the HPG concentrate because typically the crosslinks are irreversible; temporary crosslinks are preferred. If a crosslinking agent is included, it may be necessary to adjust the worse-than-theta solvent, for example, the salt, to a less strong salt. For example, sodium bromide may be useful with a borate crosslinking agent. Potassium chloride may be useful with a borate crosslinking agent. Salts that are not as strong may be used as long as they are not incompatible with borate crosslinking agents.

As an example, in one embodiment, an HPG concentrate of the present invention comprises 20% w/v HPG, 40% (w/v) ammonium sulfate, 70% alcohol (v/v), and 70% DPGME (v/v). The remaining content is water.

Although not wanting to be limited by any particular theory, it is believed that through a balance of solvents and non-solvents, the HPG polymer concentrate can be maintained in worse-than-theta conditions. This results in increased polymer loadings in the concentrate. The term “theta conditions” is explained in the following.

At the present time, it is believed that the solubility of polymers in any solution is determined by two main factors. The first is the free energy interaction between the polymer segments and the solvent. This includes any decrease in entropy arising from the non-uniform distribution of co-solvents around the polymer chain and the heat of association between the polymer segments and the solvent molecules. The second is the entropy of configuration of the polymer chains in solution. This latter term normally enhances solubility because the chains have many more configurations in solution than in the solid. However, crosslinks between the chains restrict the number of configurations and excess crosslinking can lead to the well-known syneresis effect. When the balance of these free energies is such that the polymer is just on the verge of solubility, the conditions (temperature, pH, ionic strength, etc.) are then described as “theta conditions” and the solvent as “a theta solvent.” When dry water-soluble polymers are dispersed in non-solvents, such as paraffins, the solvents are not regarded as theta solvents as changes in temperature, pressure, or polarity of the solvent, while remaining as a single-phase solvent, do not result in solubility of the polymer in the solvent.

In principal, theta solvents can be single solvents or combinations of solvents. When used in combination, they are usually a balance between a good solvent and a non-solvent.

Mixtures of solvents and non-solvents can be utilized so that HPG is just balanced between dissolved and insoluble. This mixture of solvents is a “theta solvent,” as that term is used herein. Solutions that are richer in the non-solvent so that the HPG would clearly not dissolve are referred to herein as “worse-than-theta conditions.” Worse-than-theta conditions are where the viscosity of a 1% solution of the polymer in the non-solvent would not exceed the viscosity of the pure non-solvent by a factor of three. Aqueous theta solvents for HPG would mean a mixture of water and a non-solvent such as alcohol or certain salts. In addition, crosslinking agents could also be present and contribute to the balance of free energies. Thus, a “worse-than-theta solvent” for a polymer would mean a solvent containing a mixture of water and non-solvents and/or crosslinking agents such that the polymer is insoluble in that mixture and not on the verge of solubility.

Theta conditions can be seen in measuring and analyzing the viscosity of polymer systems at various concentrations in different solvents. The viscosities of solutions of polymers in good and theta solvents are quite different. A 1% HPG solution in water has a viscosity of 140 cP at 500 s⁻¹ as measured on a HAAKE “RheoStress RS150” controlled stress rheometer at 23° C. whereas the viscosity of 1% HPG in saturated ammonium sulfate (worse-than-theta solvent) has a viscosity of 3.4 cP at 500 s⁻¹ as measured on a HAAKE “RheoStress RS150” controlled stress rheometer at 23° C. The background viscosity of saturated ammonium sulfate solution is 2.4 cP (as measured on a HAAKE “RheoStress RS150” controlled stress rheometer at 23° C.); i.e., for a high molecular weight polymer (a molecular weight of about 2 million) we would expect the ratio of viscosity of a 1% solution in a worse-than-theta solvent:viscosity of the worse-than-theta solvent to be <3. The ratio of the viscosity of a 1% solution of the same polymer in a good solvent: the viscosity of the good solvent to be >3.

As to the hydration of the concentrate to form a treatment fluid, the rate of hydration of polymers in water (or any other solvent) is dependent on a number of factors such as the molecular mass of the polymer. The molecular mass determines the entanglement of the chains. The viscosity of the solvent also affects the hydration rate because it can affect the rate of removal of chains from the concentrated polymer. The state of the hydration of the chains in the concentrated form can also affect the hydration rate. It is believed that a completely dry polymer system can be quite slow to hydrate in a solvent, even if it is ultimately completely soluble in that solvent. Leaving a small amount of solvent (e.g., a few %) in a polymer after drying increases the rate of solubility significantly, because the probability of opening interchain polymer structures in a dry polymer system by the first few solvent molecules is small. Thus, the hydration of water-soluble polymers is likely to be faster if they are in worse-than-theta aqueous conditions than if they were solid dry powders dispersed in a non-solvent such as paraffin. This is believed to be related to the rapid hydration of the HPG concentrates of the present invention. Thus, a “worse-than-theta aqueous solvent” here requires that the solvent comprise a mixture of components with at least some part (e.g., 10% or more) of water in which the polymer can be completely soluble. In addition, the other components of the solvent must be soluble in water; otherwise, an emulsion would be formed. This distinguishes these systems from those in which the dry powder is dispersed in paraffin or diesel since common polysaccharides are not soluble in paraffin.

In some embodiments, the HPG concentrate will be formed in a factory-like setting and delivered to a dock where the HPG concentrate will be pumped on to a vessel. The vessel will then go to an off-shore well site. At the well site, the HPG concentrate can be blended with an aqueous fluid (e.g., sea water) to form a subterranean treatment fluid. The dilution brings the concentration of the polymer in the subterranean treatment fluid to normal operating conditions (about 20 to about 40 lbs/1000 gal and dilutes the non-solvent), which is above theta conditions. In some embodiments, because of the relatively rapid hydration time of the HPG concentrate, smaller hydration tanks may be used (i.e., less residence time in the hydration tank is needed). Minimizing time in the hydration holding tank is of benefit.

Optionally, a crosslinking agent can be added at this time to crosslink the HPG polymer for use in the subterranean treatment fluid. Suitable crosslinking agents for use in the subterranean treatment fluid (as opposed to the HPG concentrate) may include any suitable crosslinking agent for HPG, including metal crosslinking agents, and other crosslinking agents that are typically used to crosslink HPG in subterranean treatment fluids. Other additives such as proppant may be added to the fluid as well. The subterranean treatment fluid can then be placed in the well bore for any suitable subterranean operation, such as fracturing and friction reduction.

In some embodiments, the present invention provides a method comprising the following steps: providing an HPG concentrate having a polymer load of about 2 to about 25% w/v and being present in a worse-than-theta aqueous solvent, the HPG concentrate comprising HPG and an aqueous based solvent that comprises water and a non-solvent for the HPG that is soluble in the aqueous based solvent; and diluting the HPG concentrate with an aqueous fluid to form a subterranean treatment fluid.

In some embodiments, the present invention provides a method comprising the following steps: providing an HPG concentrate having a polymer load of about 2 to about 25% w/v and being present in a worse-than-theta aqueous solvent, diluting the HPG concentrate so as to form a subterranean treatment fluid having better than theta conditions; and placing the subterranean treatment fluid in an off-shore well bore.

In some embodiments, the present invention provides a method comprising: providing an HPG concentrate in a storage vessel, the HPG concentrate having a polymer load of about 2 to about 25% w/v and being present in a worse-than-theta aqueous solvent: comprising HPG and an aqueous based solvent that comprises water and a non-solvent for the HPG, and diluting the HPG concentrate to form a gelled fluid having better than theta conditions; and placing the gelled fluid in a subterranean formation.

In some embodiments, the present invention provides an HPG concentrate having a polymer load of about 2 to about 25% w/v and being present in a worse-than-theta aqueous solvent comprising HPG and an aqueous based solvent that comprises water and a non-solvent for the HPG, and optionally a crosslinking agent.

To facilitate a better understanding of the present invention, the following examples of preferred embodiments are given. In no way should the following examples be read to limit, or to define, the scope of the invention.

### EXAMPLES

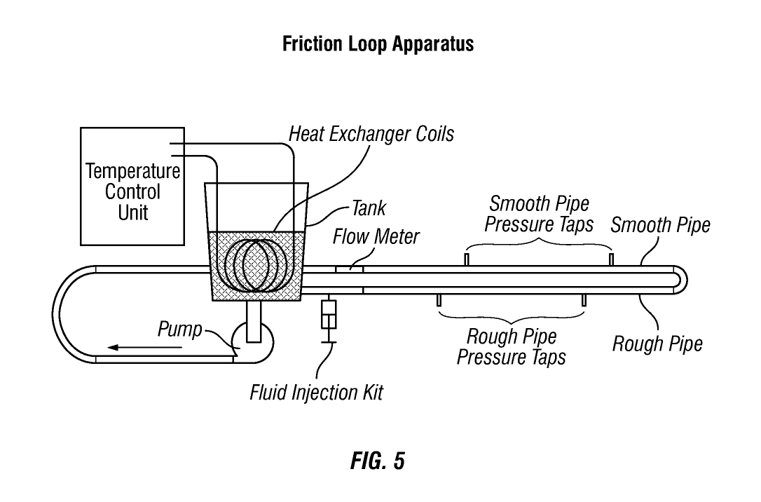

Friction loop testing is performed to indicate the rate of hydration of the HPG polymer. When fluids are pumped along a pipe it is known that as the flow rate increases, turbulence will begin to take place, resulting in additional energy required to pump at the given rate. This extra energy, sometimes called friction, can be reduced significantly by incorporating high molecular mass polymers. Indeed, this is standard practice in water fracturing of shales. Reduction of turbulence increases with polymer concentration until a plateau is reached. Below that plateau, turbulence reduction is mainly determined by the polymer concentration. Thus when operating below the polymer concentration required to give this plateau the reduction of friction is an indication of the amount of polymer dissolved in the solution. Thus, the friction reduction measurement in the friction loop gives a rapid measure of the rate of hydration of the polymer. FIG. 5 illustrates a schematic of a friction loop that was used in the testing.

The apparatus for measuring friction reduction, shown in FIG. 5, has a tank (˜16 liters) from which a low shear progressive cavity pump (“MOYNO 2L6”) circulated fluid around two pipes, each of about 5 m total length, diameter 1.25 cm, but of different roughness. All the data shown here are for the flow in the smooth pipe. Total volume of the fluid system was 20 liters. A temperature control unit maintained the temperature of the circulating fluid at 25° C.

The pressure drop across a 2.4 m length of pipe was measured by a pressure transducer. The polymer solutions were injected into the pipe from a syringe, located 15 cm from the inlet to the tank. The entrance into the tank was via a Y-shaped pipe fitting to provide rapid distribution of the injected polymer into the bulk solution. The friction reduction experiments were run by initially pumping the base fluid (water or salt solution) at a chosen rate to establish the pressure drop for the base solution and this was compared with the value for water. As some salt solutions are more viscous than water, the initial friction reductions appear as a slightly negative value. After 1.2 minutes, the polymer solution was injected by pneumatic pressure into the pipe and the pressure difference across the 2.4 m length of smooth pipe recorded. The friction reduction was calculated by the equation:

%FR=100×(ΔPₛ−ΔPₚ)/ΔPₛ

where ΔPₛ is the pressure drop across the 2.4 m pipe length for water and ΔPₚ is that due to the polymer solution.

Friction Loop Testing to Show Polymer Hydration

In these tests, HPG polymer was dispersed in a variety of “worse-than-theta aqueous solvents” and their rates of hydration were studied by examination through friction reduction studies in a friction reduction loop. FIG. 5 illustrates the friction reduction loop that was used.

The rate of hydration of the polymer was taken to be the time required to achieve maximum friction reduction after injection into the friction loop. HPG polymer (10 g) was dispersed into 50 ml of a solvent containing water and a non-solvent such as ethanol, DPGME (dipropyl glycol methylether) or ammonium sulfate. 20 ml of this dispersion was injected into the water (initially adjusted to pH of 5.7) in the friction loop at 77° F. run at 10 gpm for 10 minutes after the injection. The time to reach maximum friction reduction was noted and is shown in Table 3. The chemicals used in these experiments are shown in Table 1.

TABLE 1

| Chemical | Supplier |
|---|---|
| HPG powder under the tradename | Rhodia |
| “WG-11” | |
| Ammonium Sulfate | J. T. Baker; ACS reagent grade |
| Alcohol | Fisher Scientific; ~98% ethanol |
| “EXXSOL D95” | ExxonMobil Chemical |

Non-solvents for WG-11 were established by dispersing 5 g of WG-11 in 50 mL of alcohol and (separately) DPGME and leaving to dissolve overnight (˜16 hours). No increase in viscosity of the solvents was observed and the WG-11 powder sedimented to a small volume (˜15%) on standing for that time. This showed that both alcohol and DPGME were non-solvents for WG-11.

Dispersions of WG-11 were made by stirring the WG-11 powder (10 g) into the solvents (50 ml) and leaving to equilibrate overnight (˜16 hours). For the friction loop experiments, 20 ml of the dispersion was injection into 20 l of water where the pH had been adjusted to 5.7. This slightly acidic water allowed the borate crosslinks in the WG-11 to break and the HPG to hydrate and dissolve. The friction reduction for each of the systems shown in Table 2 are plotted in the figures below. Saturated ammonium sulfate was prepared by adding sufficient of this salt to water followed by stirring overnight so that a residual amount of undissolved salt remained. The required volume of solution (50 mL) was poured off and used to disperse the WG-11.

TABLE 2

| Solvent System | Contents |
|---|---|
| Alcohol/water | 70% ethanol + 30% water |
| DPGME/water | 70% DPGME + 30% water |
| Saturated ammonium sulfate | 43% ammonium sulfate in water |
| Exxsol D95 | Non-aromatic hydrocarbon solvent (100%) |

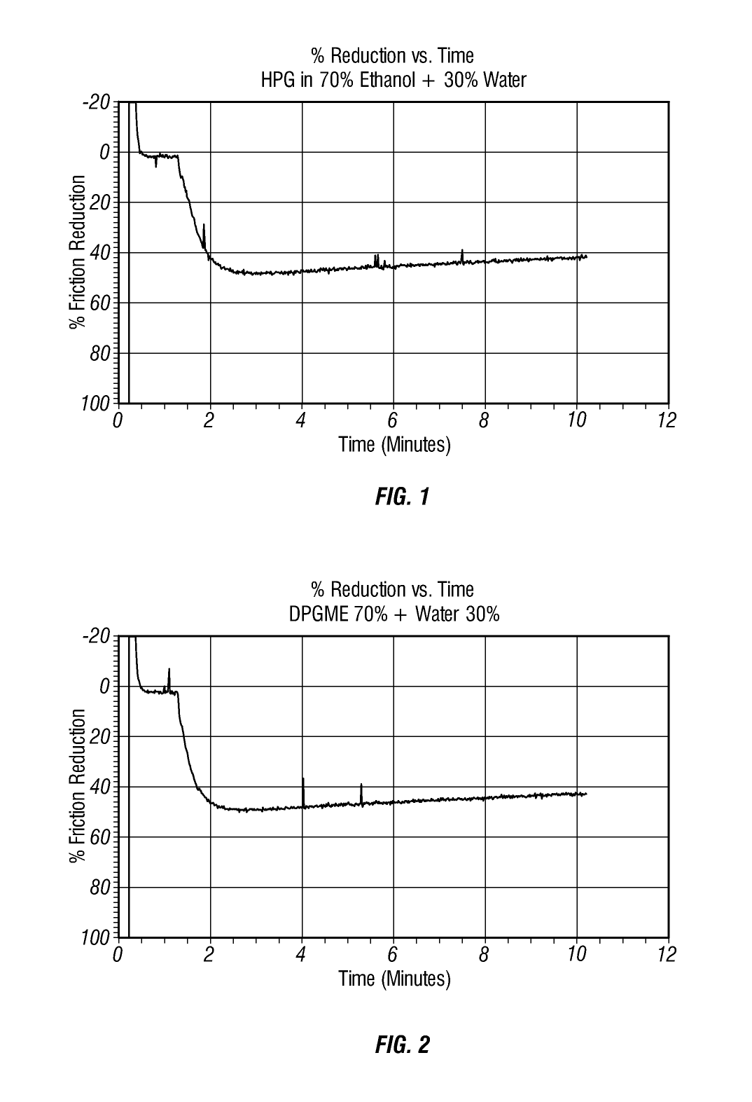

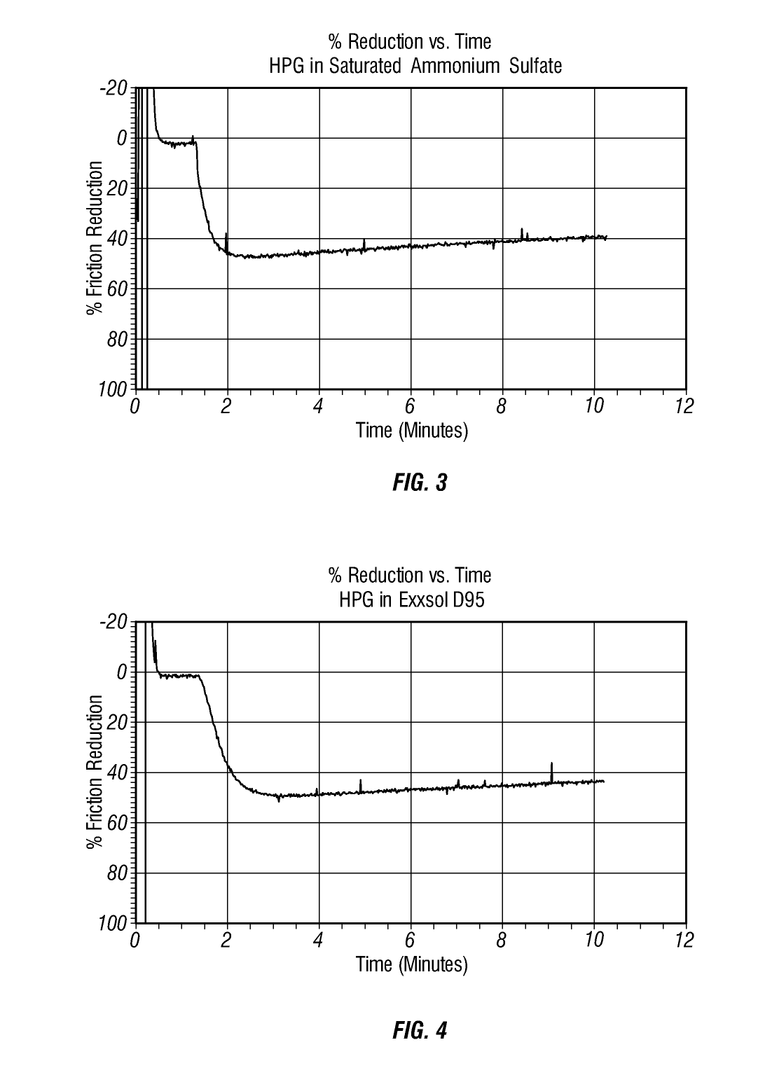

Friction reduction was measured as described previously at a flow rate of 10 gpm for 10 minutes after injection the friction reducing agent. The graph of friction reduction as a function of time for the alcohol system is shown in FIG. 1. The friction reduction in DPGME/water system is shown in FIG. 2. The friction reduction in the saturated ammonium sulfate is shown in FIG. 3. The friction reduction for HPG dispersed in the hydrocarbon Exxsol D95 is shown in FIG. 4. The time taken to reach maximum friction reduction after injection at 1.2 minutes (i.e., the time at maximum friction reduction is 1.2 mins) is given in Table 3.

TABLE 3

| | Solvent System | | | |
|---|---|---|---|---|
| | | | Saturated | |
| | | | Ammonium | |
| | Alcohol | DPGME | Sulfate | Exxsol D95 |
| Time to | 1.7 | 1.4 | 1.13 | 1.91 |
| maximum | | | | |
| hydration | | | | |
| (min) | | | | |

All the systems of HPG in worse-than-theta aqueous solvents had faster hydration times than the dispersion of HPG in hydrocarbon. Thus, it is expected that these solvents would be better suited to dispensing HPG on sea-going vessels for at least two possible reasons: (1) that the faster hydration means that less storage space should be needed for the hydrating polymer before any crosslinking agent can be added, and (2) since all of the components are water soluble, no oil sheen should be produced if the HPG were spilled in the sea.

From the above, it appears that WG-11 can be suspended in aqueous solvents that are “worse-than-theta”—meaning that the polymer chains are effectively tightly compressed so that a ˜10% dispersion has a low enough viscosity to be easily pumped. On mixing with water these dispersions, give fast hydration, at least as fast as hydrocarbon-based LGC. Thus, they appear to be suitable for application in sea-going vessels where space is at a premium and fluids are preferred that show no sheen if spilled on the sea surface.

The viscosity of a 1% HPG in pure water is 140 cP at 500 s−1 measured on a HAAKE “RheoStress RS150” controlled stress rheometer at 23° C. A 5% HPG solution in pure water forms a self-supporting gel that cannot be pumped. A 16% solution of HPG in a worse-than-theta aqueous solvent is 150 cP 500 s−1 measured on a HAAKE “RheoStress RS150” controlled stress rheometer at 23° C.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents referenced herein, the definitions that are consistent with this specification should be adopted.

What is claimed is:

1. A method comprising:
providing an HPG concentrate having a polymer load of about 2 to about 25% w/v and being present in a worse-than-theta aqueous solvent, the HPG concentrate comprising HPG polymer and an aqueous based solvent that comprises water and a non-solvent for the HPG that is soluble in the aqueous based solvent; and
diluting the HPG concentrate with an aqueous fluid to form a subterranean treatment fluid.

2. The method of claim 1 further comprising placing the subterranean treatment fluid in an off-shore well bore.

3. The method of claim 2 wherein placing the subterranean treatment fluid in an off-shore well bore involves a fracturing operation.

4. The method of claim 1 wherein the non-solvent comprises a salt, an alcohol, a glycol, and an ester, and any combination thereof.

5. The method of claim 1 wherein at least a portion of the HPG concentrate comprises crosslinked HPG polymer.

6. The method of claim 1 wherein the worse-than-theta solvent comprises ammonium sulfate, sodium nitrate, potassium carbonate, sodium bromide, potassium chloride, sodium chloride and any combination thereof.

7. The method of claim 1 wherein the water is present in an amount of at least 5% by volume.

8. A method comprising:
providing an HPG concentrate having a polymer load of about 2 to about 25% w/v and being present in a worse-than-theta aqueous solvent, and
diluting the HPG concentrate so as to form a subterranean treatment fluid having better-than-theta conditions; and
placing the subterranean treatment fluid in an off-shore well bore.

9. The method of claim 8 wherein placing the subterranean treatment fluid in an off-shore well bore involves a fracturing operation.

10. The method of claim 8 wherein the non-solvent comprises a salt, an alcohol, a glycol, and an ester, and any combination thereof.

11. The method of claim 8 wherein at least a portion of the HPG concentrate comprises crosslinked HPG.

12. The method of claim 8 wherein the non-solvent comprises ammonium sulfate, sodium nitrate, potassium carbonate, sodium bromide, potassium chloride, sodium chloride and any combination thereof.

13. The method of claim 8 wherein the water is present in an amount of at least 5% by volume.

14. A method comprising:
providing an HPG concentrate in a storage vessel, the HPG concentrate having a polymer load of about 2 to about 25% w/v and being present at worse-than-theta conditions comprising:
HPG polymer, and
an aqueous solvent that comprises water and a non-solvent for the HPG polymer, and
diluting the HPG concentrate to form a gelled fluid having better than theta conditions; and
placing the gelled fluid in a subterranean formation.

15. The method of claim 14 wherein placing the subterranean treatment fluid in a subterranean formation involves a fracturing operation.

16. The method of claim 14 wherein the worse-than-theta solvent comprises a salt, an alcohol, a glycol, and an ester, and any combination thereof.

17. The method of claim 14 wherein at least a portion of the HPG concentrate comprises crosslinked HPG polymer.

18. The method of claim 14 wherein the worse-than-theta solvent comprises ammonium sulfate, sodium nitrate, potassium carbonate, sodium bromide, potassium chloride, sodium chloride and any combination thereof.

19. The method of claim 14 wherein the water is present in an amount of at least 5% by volume.

20. An HPG concentrate having a polymer load of about 2 to about 25% w/v and being present at worse-than-theta conditions comprising HPG polymer and an aqueous based solvent that comprises at least about 5% water and a non-solvent for the HPG and optionally a crosslinking agent.
